(19) United States
(12) Patent Application Publication
(10) Pub. No.: US 2011/0073420 A1
(43) Pub. Date: Mar. 31, 2011

(54) HIGH PRESSURE SWITCH

(75) Inventor: Douglas Jon Nagel, Waterloo, IA (US)

(73) Assignee: Engineered Products Company, Waterloo, IA (US)

(21) Appl. No.: 12/889,393

(22) Filed: Sep. 23, 2010

Related U.S. Application Data
(60) Provisional application No. 61/277,278, filed on Sep. 23, 2009.

(51) Int. Cl. B60T 11/10; H01H 35/38

(52) U.S. Cl. 188/152; 200/82 R

(57) ABSTRACT

The present inventor devised, among other things, an exemplary pressure switch that includes a low-pressure switch housing portion and a high-pressure fitting portion. The low-pressure switch housing, which is formed of plastic for example, includes an electrical switch that can be turned on or off by moving a first contact between a pair of stationary contacts. The high-pressure fitting portion, which is formed of metal for example, has first and second barbed or threaded connector ends, which respectively engage an opening in the switch housing and a fluid line of an external system. An axial bore extending through the high-pressure fitting contains a piston which extends into the switch housing and is fastened to the first contact of the electrical switch. In operation, the piston travels within the bore in response to positive or negative pressure, moving the first contact toward or away from the stationary contacts to open or close the switch.

### RELATED APPLICATION

This application claims priority to U.S. Provisional Patent Application 61/277,278, which was filed Sep. 23, 2009 and which is incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2009 Engineered Products Company, Inc.

### TECHNICAL FIELD

Various embodiments of the present invention concern pressure switches, particularly low-cost pressure switches suitable for high positive or negative pressures.

### BACKGROUND

Many modern systems include pressure switches, devices that turn on or off electrical circuits in response to sensed pressure conditions. For examples, in automobiles or earth-moving equipment, pressure switches sense engine oil pressure or hydraulic fluid pressure and turn on warning lights and/or shut down the engine in response to particular over- or under-pressure conditions, thereby signaling maintenance needs or preventing irreparable damage. Also, air-braking systems in tractor-trailer trucks employ pressure switches to activate brake lights when a driver steps on the brakes and thus provide brake signal to others.

The present inventor has recognized that conventional pressure switches suffer from several problems. For examples, for high-pressure applications many conventional pressure switches use a diaphragm—typically a plastic and/or rubber-like disk that flexes in response to differences in the pressures on its top and bottom sides. However, to endure the corrosive nature of some fluids, the diaphragm must be made of expensive materials. Moreover, to withstand the high pressures of some applications, the diaphragm and/or switch housing must be reinforced with thicker materials and flex-limiting features. The use of the special materials, reinforcements, and flex-limiting features increases the cost of manufacturing these switches and makes them more costly to include in vehicles or other systems that need them. Moreover, even with use of these materials and reinforcements, pressure switches in these environments are shorter lived and less reliable than desired.

Accordingly, the present inventor identified a need for better pressure switches, particular pressure switches that are suitable for high positive and negative pressure applications.

### SUMMARY

To address this and/or other needs, the present inventor devised, among other things, pressure switches, assemblies, components, and related methods and systems incorporating these innovations. One exemplary pressure switch includes a low-pressure portion and a high-pressure portion. The low-pressure portion, which is formed of plastic for example, includes an electrical switch that can be turned on or off by moving a movable conductor into or out of contact with a pair of stationary contacts.

The high-pressure portion, which is formed of metal for example, has first and second barbed or threaded connector ends, with the first connector end engaging an opening in the low-pressure portion, and the second connector end in fluid communication with an external system. An axial bore extending through the high-pressure portion contains a piston. Extending through the opening in the low-pressure portion, one end of the piston is mechanically coupled to the movable conductor of the electrical switch.

The piston travels within the bore in response to positive or negative pressure, thereby moving the movable conductor toward or away from the stationary contacts to open or close the switch. In some embodiments, the axial bore and the piston are configured to prevent the piston from escaping from the high-pressure portion of the pressure switch. Some embodiments also include one or more U-seal O-rings between the piston and the interior surface of the axial bore, as well as one or more calibration springs for biasing piston movement.

Notably, the exemplary pressure switch omits a diaphragm and uses a piston instead, thereby avoiding the issues related to limiting diaphragm flexure in high-pressure applications and using costly exotic flexible materials to withstand harsh fluid environments.

### BRIEF DESCRIPTION OF DRAWINGS

FIG. 1 is a cross-sectional diagram of an exemplary pressure switch 100 corresponding to one or more embodiments of the invention.

FIG. 2A is a side perspective view of an exemplary pressure switch 200 corresponding to one or more embodiments of the invention.

FIG. 2B is a cross-sectional view of exemplary pressure switch 200 corresponding to one or more embodiments of the invention.

FIG. 2C is a perspective view of an exemplary switch module portion of pressure switch 200 corresponding to one or more embodiments of the invention.

FIG. 2D is a perspective view of a terminal portion of the switch module shown in FIG. 2C and thus corresponding to one or more embodiments of the present invention.

FIG. 3A is a cross-sectional view of an exemplary pressure switch 300 corresponding to one or more embodiments of the present invention.

FIG. 3B is a perspective cross-sectional view of a push plate portion of pressure switch 300 corresponding to one or more embodiments of the present invention.

FIG. 3C is a cross-sectional view of an alternative switching contact arrangement corresponding to one or more embodiments of the present invention.

FIG. 4 is a cross-sectional view of an exemplary pressure switch 400 corresponding to one or more embodiments of the present invention.

FIG. 5 is a cross-sectional view of an exemplary pressure switch 500 corresponding to one or more embodiments of the present invention.

FIG. 6 is a diagram of an exemplary braking system 600 which corresponds to one or more embodiments of the present invention.

### DETAILED DESCRIPTION OF EXEMPLARY EMBODIMENTS

This description, which incorporates the above-identified figures and appended claims, describes one or more specific inventive embodiments. These embodiments, offered not to limit but only to exemplify and teach one or more inventions, are shown and described in sufficient detail to enable those skilled in the art to implement or practice the invention(s). The description may use terms, such as upper or lower in reference to specific features of various as embodiments; however, unless included in the claims, such terms are merely to aid correlating the drawings with the written description. Moreover, where appropriate to avoid obscuring the invention(s), the description may omit certain information known to those of skill in the art. U.S. Pat. No. 7,414,207 is incorporated herein by reference.

### Exemplary Pressure Switch Embodiments

### First Exemplary Pressure Switch

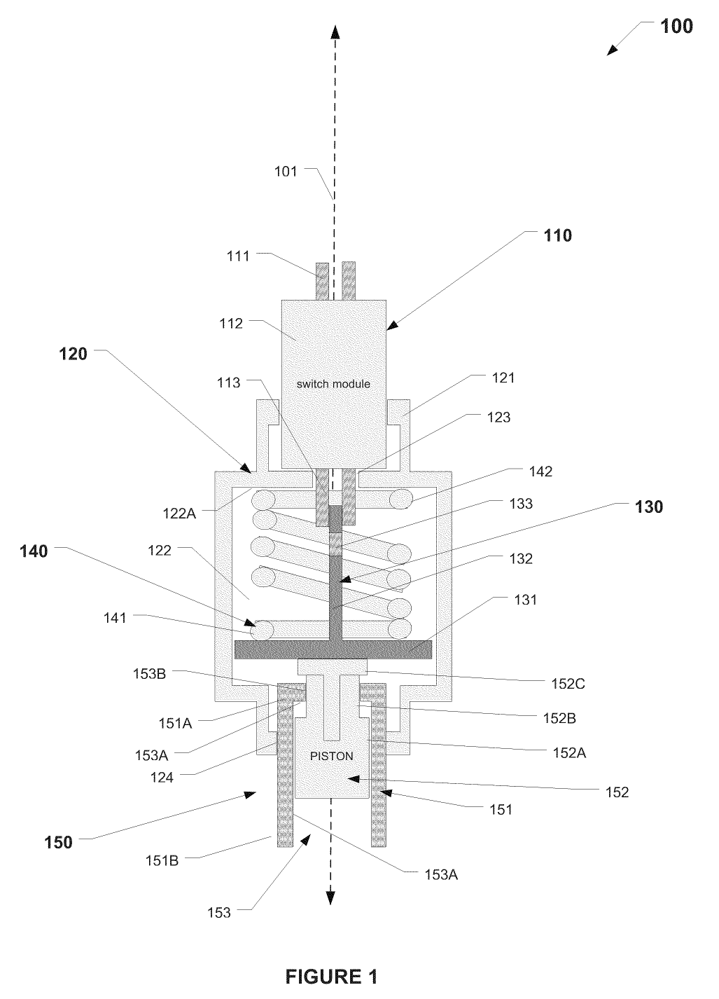

FIG. 1 shows a cross-sectional block diagram of an exemplary pressure switch 100 which incorporates teachings of the present invention. Pressure switch 100 includes a switch or terminal module 110, a low-pressure housing portion 120, a push plate assembly 130, a calibration spring 140, and a high-pressure fitting assembly 150, all of which are centered on an axis 101.

Switch or connection module 110 includes a pair of terminals or leads 111 for connection to an external electrical circuit (not shown), a switch body 112, and a pair of contacts 113. Switch body 112 is permanently or removably seated within a switch-module receiving portion 121 of low-pressure housing portion 120.

Low-pressure housing portion 120, which in the exemplary embodiment is injection molded from a plastic or nylon material, defines an interior chamber 122 and includes an upper opening 123 and a lower opening 124. Extending through upper opening 123 into interior chamber 122 are contacts 113.

Push plate assembly 130, which is contained within chamber 121, includes a circular plate portion 131 and a central pin portion 132. Circular plate portion 131 has a diameter less than that of chamber 122 to allow free vertical movement of the push plate assembly within the chamber. Central pin portion 132, which is integrally molded of a non-conductive material such as plastic or nylon, with plate portion 131, projects perpendicularly from a central region of plate portion 131 toward upper opening 122 and between contacts 113. Central pin portion 132 includes a conductive portion 133 which in the exemplary embodiment takes the form of a brass or copper bushing. Centered around central pin portion 132 (and contacts 113) is calibration spring 140.

Calibration spring 140 has a lower portion 141 seated against plate portion 131 and an upper portion 142 seated against an upper surface 121A of chamber 121. Calibration spring 140 biases push plate assembly 130 toward lower opening 123 in low-pressure housing 120. Extending through lower opening 123 to engage or contact push plate portion 131 is a piston portion 152 of high pressure fitting assembly 150.

High-pressure fitting assembly 150 includes a high-pressure fitting portion 151 and piston portion 152. High-pressure fitting portion 151, which is formed of stainless steel and is generally cylindrical in form in the exemplary embodiment, includes upper and lower connection ends 151A and 151B that respectively engage in fluid tight coupling, for example via threads or barbs, with lower opening 124 in low-pressure housing 120 and with an opening in a fluid line of an external system (not shown). Extending through fitting portion 151 is a stepped axial bore 153, which includes a first diameter portion 153A and a smaller second diameter portion 153B, which together define an inner annular shoulder 153C adjacent to upper connector end 151A. (In some embodiments, fitting portion 151 is molded of a heavy-duty plastic or nylon material and/or molded integral with lower housing portion.) Positioned within axial bore 154 is piston portion 152.

Piston portion 152, which is generally cylindrical and longer in its axial dimension than its diameter or width, includes respective first, second, and third diameter portions 152A, 152B, and 152C. First diameter portion 152A is slightly smaller than the first diameter portion of axial bore 153; second diameter portion 152B is slightly smaller than the second diameter portion of axial bore 153. The first and second diameter portions 152A and 152B together define an outer annular shoulder that prevents passage of piston portion 152 in an upward direction through upper end 151A of fitting portion 151. Third diameter portion 152C is larger than the second diameter of axial bore 154 and is entirely outside the axial bore, limiting downward travel of piston 152 through axial bore 154. In the exemplary embodiment, piston portion 152 is injection molded from a plastic or nylon material.

In normal operation, pressure switch 100 is electrically coupled via contacts 111 to an electric circuit such as a circuit having a battery and a light and/or computer and fluidly coupled via the lower connection end of high-pressure fitting assembly 150 to an external system having a pump coupled via a fluid line to an engine or to one or more pneumatic or hydraulic devices. Piston portion 152 responds to positive or negative pressures in fluid line by moving upwardly or downwardly within axial bore 154, assuming sufficient pressure to overcome the bias of calibration spring 140. Movement of piston portion 152 results in movement of push plate 130 and conductive portion 133 toward or away from contacts 113. Sufficient movement of the piston will result in making or breaking an electrical connection between contacts 113, depending on the initial position of conductive portion 133. If the contacts are connected in series with a light and a battery, making the connection results in illumination of the light, and breaking the connection opens the circuit and results in turning off the light.

### Second Exemplary Pressure Switch

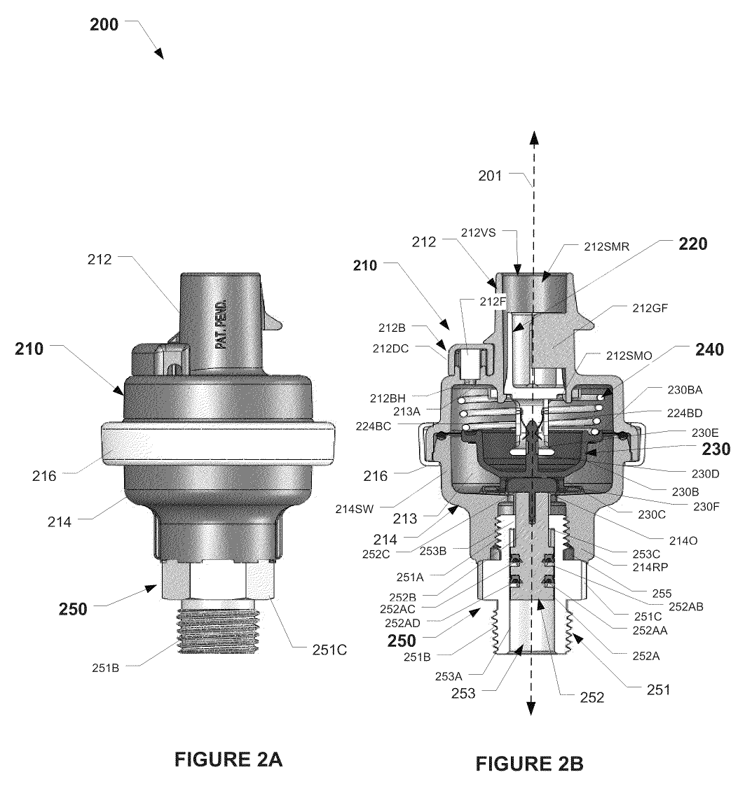

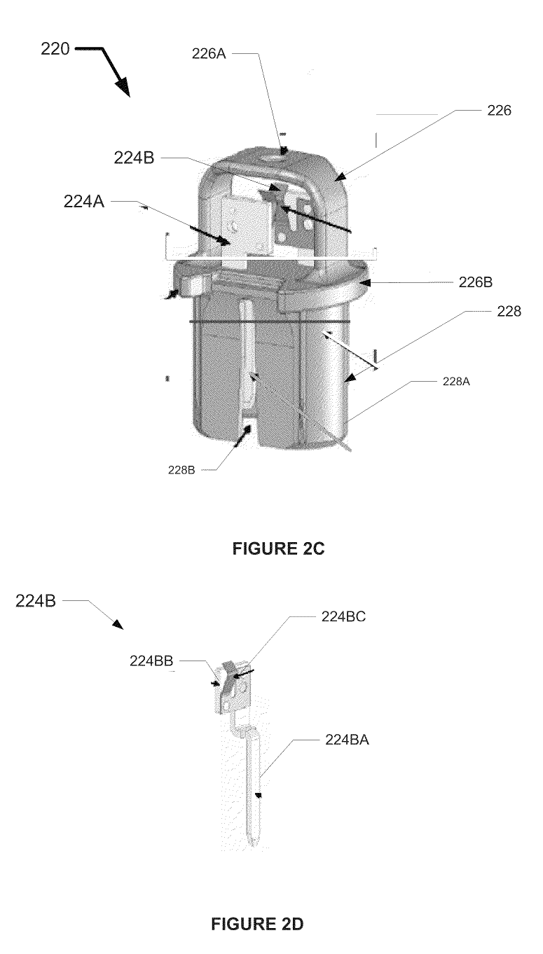

FIGS. 2A and 2B respectively show side perspective and center cross-sectional views of an exemplary pressure switch 200, which is similar in form and function to pressure switch 100. Switch 200 includes a low-pressure housing assembly 210, a switch or terminal module 220, a push plate assembly 230, a calibration spring 240, and a high-pressure fitting assembly 250, coaxially arranged along a central axis 201.

Low-pressure housing assembly 210, which includes an upper housing portion 212, a lower housing portion 214, and a collar 216. In the exemplary embodiment, all components of the housing assembly, except for filter 216B and collar 216 are molded from Clariant Nylon 6/6 (13% Glass Filled.). Filter 216B is formed of Teflon PTFE, and collar 218 is formed of aluminum, with edge rolled down after assembly of the switch. More particularly, upper housing portion 212, which is generally horn-shaped in the exemplary embodiment, includes a breather hole 212BH, a filtration system 212FS, a switch module receiving portion 212SMR. Breather hole 212BH is in fluid communication with the atmosphere via filtration system 212FS, which includes a dust cover 212DC and a filter 212F. Switch module receiving portion 212SMR includes a vertical sidewall 212VS surrounding a switch module opening 212SMO and including a guide fin portion 212GF, which engages a slot in switch module 220. Upper housing portion 212 is attached to lower housing portion 214, for example via a snap fit, defining an interior chamber 213 analogous to interior chamber 122 in FIG. 1.

Lower housing portion 214, which in the exemplary embodiment has a generally cup-like structure, includes a sidewall 214SW and a high-pressure fitting assembly receiving portion 214RP. High pressure fitting assembly receiving portion 214RP includes an opening 214O.

Collar 216 encircles the snap-fit interface between upper and lower housing portions 212 and 214 to add further integrity and aesthetic appeal to the switch. Collar 218 includes upper and lower rolled edges 218A and 218B. Some embodiments omit collar 216.

Switch or terminal module 220 fits within switch module receiving portion 212SMR and extends partially through switch module opening 212SMO into chamber 213. Switch module 220, shown in isolation and perspective in FIG. 2C, includes a terminal pair 224 and upper and lower portions 226 and 228. (Module 220 is inverted in FIG. 2C relative to its orientation in FIG. 2B.) Terminal pair 224 includes substantially identical non-contacting terminals 224A and 224B. Shown best in FIG. 2D, terminal 224B includes a terminal pin 224BA, a terminal pad 224BB, and a leaf contact 224BC. (Only the leaf contacts are clearly visible in the cross-sectional view of FIG. 2B.) Terminal pin 224BA, which is sized to engage or mate with a female connector (not shown), is formed of half-hardened brass and tin plated. Substantially covering terminal pad 224BB, leaf contact 234BC is formed of beryllium-copper and includes a spring portion 224BD. Insert-molded around terminal pair 224 are upper and lower module portions 226 and 228.

In the exemplary embodiment, switch module portions 226 and 228 are formed of Vydyne Nylon 6/6 22 HSP. Upper portion 226 includes guide hole 226A and module support 226B. Lower portion 228 has a sleeve portion 228A with a notch 228B, with the sleeve portion extending from the opposite side of the module support. Notch 228B extends along the length of the sleeve portion and engages, as FIG. 2B shows, with guide fin 212GF in the switch module receiving portion 212SMR of upper housing portion 212 to ensure alignment of guide hole 226A with central axis 201. The module support 226B is sealed around the prongs (terminals) to prevent contaminants from entering chamber 213 via switch module opening 212SMO (FIG. 2B).

In the exemplary embodiment, the terminal-module-to-upper-housing interface is not fluid tight; however, a suitable connector adapted to fit within the module-receiving portion of 214 can seal this portion of the cap and restrict breathing of the chamber to filtration system 212B. The module structure is also attached to the cap, and the module structure does not move with respect to the housing assembly.

FIG. 2B shows that push plate assembly 230, which is generally a bell-shaped structure molded from Vydyne 22HSP Nylon, includes an annular wall portion 230B, a plate portion 230C, a pin portion 230D, and conductive bushing 230E. Annular wall portion 230B includes an upper brim portion 230BA. Plate portion 230C is bounded by annular wall portion 230B, and positioned intermediate upper brim portion 230BA and piston receiving fingers 230F.

Analogous to pin portion 132 in FIG. 1, pin portion 230D extends orthogonally from a central region of plate portion 230C, with the upper end of the pin portion encircled by conductive bushing 230E. In one embodiment, conductive bushing is positioned closer to the end of the pin to define the switch as a normally open switch, and in another, it is positioned further from the end of the pin to define a normally closed contact. The majority of the length of pin portion 230D extends through a guide hole 226A of terminal module 220 and between leaf contacts 224BC and 224BD.

Upper brim portion 230BA of the push plate assembly serves as seat for a lower end portion 241 of calibration spring 240. An upper end portion 242 of the spring contacts an upper surface 213A of chamber 213, biasing the push plate assembly downward. An underside of plate portion 230C includes six circumferentially spaced fingers 230F which engage with a portion of high pressure fitting assembly 250.

More specifically, high pressure fitting assembly 250, analogous to high pressure fitting assembly 150 in FIG. 1, includes a high-pressure fitting portion 251 and a piston portion 252. High-pressure fitting portion 251, which is machined from 303 stainless steel in the exemplary embodiment or molded from a plastic or nylon in some other embodiments, includes upper and lower connection ends 251A and 251B and an intermediate hex-nut portion 253C. Upper and lower connection ends respectively engage in fluid tight coupling, for example via external threads, with lower opening 214O in lower housing portion 214 and with an opening in a fluid line of an external system (not shown). (An O-ring 255 encircles a lower portion of upper connection end 251A to further seal opening 214O.) Extending through fitting portion 251 is a stepped axial bore 253, which includes a first diameter portion 253A and a smaller second diameter portion 253B, which together define an inner annular shoulder 253C adjacent to upper connection end 253A. Positioned within axial bore 254 is piston portion 252.

Piston portion 252, which is generally cylindrical and longer in its axial dimension than its diameter or width, includes respective first, second, and third diameter portions 252A, 252B, and 252C. First diameter portion 252A fits within the first diameter portion 253A of axial bore 253 and includes grooves or channels 252AA and 252AB for holding respective piston seals 252AC and 252AD.

In the exemplary embodiment these seals take the form of U-seal O-rings, with the cupped or U-portion facing toward the applied pressure. In normal operation as pressure is applied, the U-seal O-rings are forced to expand and apply a seal against the internal wall of the axial bore (piston chamber). The fitting, which is made of stainless steel and serves as a cylinder or piston chamber, is polished, by for example, electropolishing, roller-burnishing or other polishing technique(s) to eight microns to enhance the life of the seals. Some embodiments form the fitting from brass. Exemplary seal materials include Viton Flourosilicone rubber to withstand automotive chemicals, and HSBN or Buna-Nitrile materials depending on the switch operating environment and the pressures involved. In one embodiment, a Buna seal lasted through 500,000+ cycles.

Notably two seals are used on separate channels along the piston for added safety in the event one of them fails. The two seals also function to hold the seal lubricant (dry graphite or synthetic oil) between the seals, which is useful for air-brake system applications at low pressure under very low temperatures. Without lubrication, the seals may stick and prevent immediate function of the switch.

In the exemplary embodiment, the piston seal assembly moves approximately 0.25″ for a full stroke of the piston.

In manufacturing the switch, the piston assembly is inserted into the pressure fitting from the pressure port side. The piston is inserted up to the point where the piston bottoms out on the shoulder of the fitting. As the piston is held in this position, the (Delrin) Alignment Pin is inserted into the cavity at the protruding end of the Piston. The Piston and Alignment Pin are pressed together and securely locked by an interference fit. Delrin material is desirable because of its easy machinability, its resistance to temperature extremes, and its low frictional resistance.

The alignment pin also serves the function of seating with the six fingers of the Pushpin/push plate. The two seals also help to maintain the alignment of the piston within the fitting so that in some embodiments the seal is the only portion of the piston assembly in contact with the side walls of the Fitting, further helping to reduce friction. In the exemplary embodiment, having the piston and alignment pin locked together helps maintain alignment of the central pushpin with the switch module. In conventional designs having a diaphragm, the diaphragm would provide this function.

In this figure, the U-seals O-rings are oriented downward; second diameter portion 252B fits within the second diameter portion of axial bore 254. The first and second diameter portions 252A and 252B together define an outer annular shoulder that prevents passage of piston 252 in an upward direction through upper end 253A.

Third diameter portion 252C is larger than the second diameter of axial bore 253 and is entirely outside the axial bore, limiting downward travel of piston 252 through axial bore 254. In the exemplary embodiment, the third diameter portion is formed separately as a plunger shape that can be glued or press fit into an axial bore within the second diameter portion 252B. In the exemplary embodiment, piston portion 252 is injection molded or machined from a plastic or nylon material, such as Delrin plastic

### Third Exemplary Pressure Switch

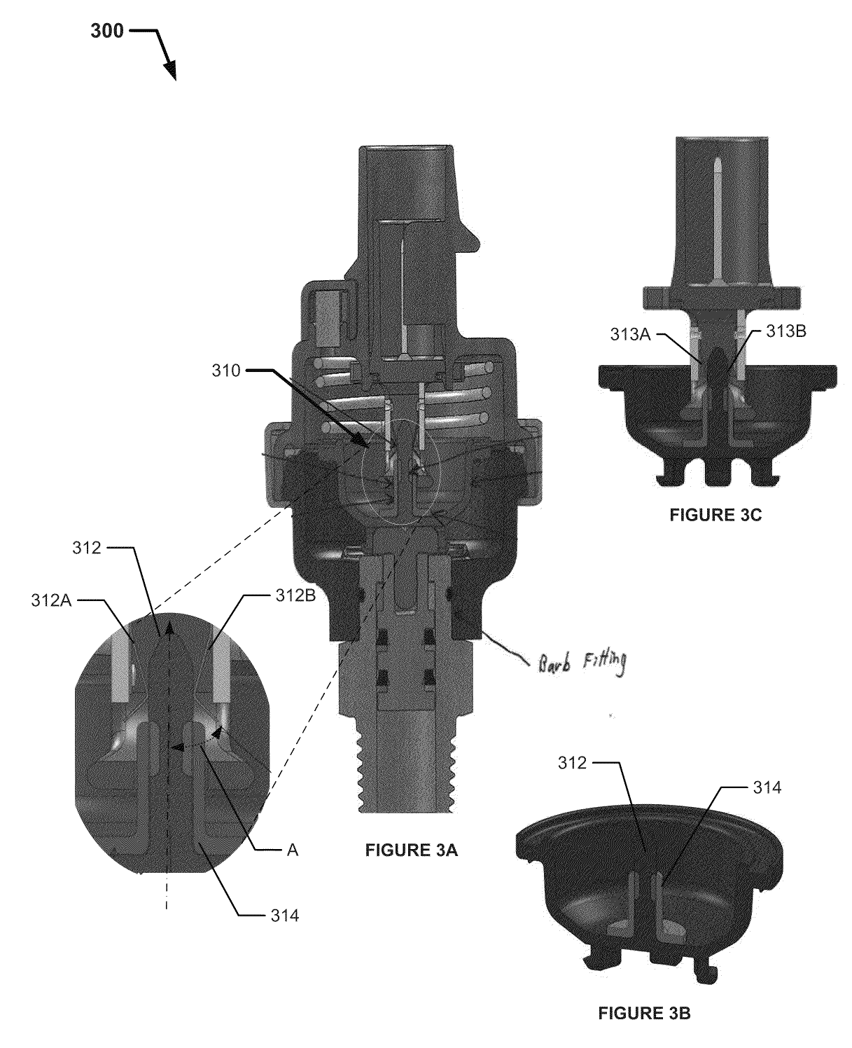

FIG. 3A shows a cross-sectional view of an exemplary pressure switch 300, which is structurally and functionally similar to switches 100 and 200, with the exception that switch 300 includes a low friction switch configuration 310 and high-pressure fitting assembly 320 includes a barbed fitting on the upper connection end that mates with the lower portion of the low pressure housing assembly.

Low friction switch configuration 310 is similar to the switching arrangement in switch 200 comprising leaf contacts 224BC and 224BC and conductive bushing XXX, except that leaf contacts 312A and 312B are spaced to avoid constant contact with central pin 314 and the conductive bushing has been replaced with a larger flanged conductive bushing 314. The flange in this embodiment is optional; however, it facilitates handling and installation of the bushing during manufacture. FIG. 3B shows a cross-sectional perspective view of flanged conductive bushing 314 mounted to central pin of the push plate. FIG. 3C shows another alternative leaf contact and conductive bushing configuration, where the leaf contacts are curved or arcuate.

### Fourth Exemplary Pressure Switch

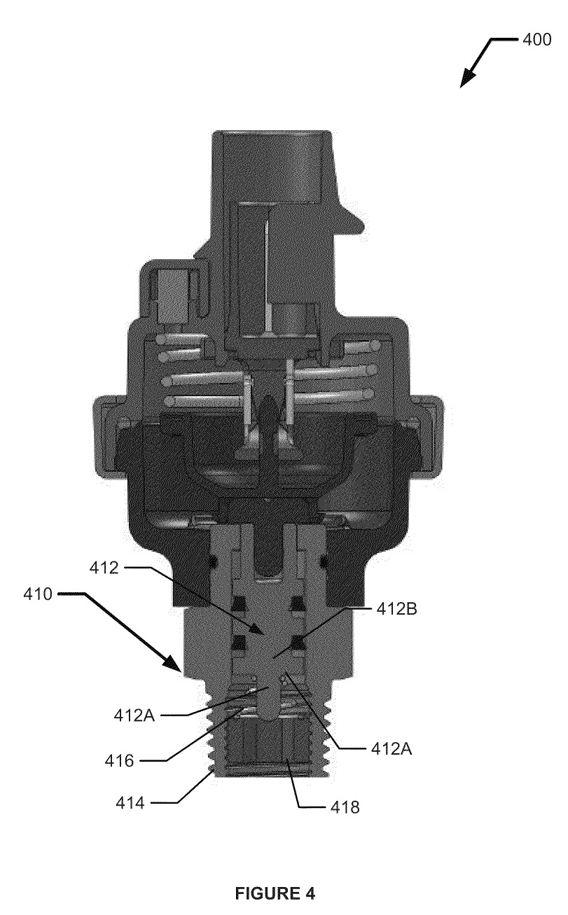

FIG. 4 shows a cross-sectional view of an exemplary pressure switch 400, which is structurally and functionally analogous, to switches 100, 200, and 300, with the exception that switch 400 includes an alternative barbed pressure fitting assembly 410. In particular, pressure fitting assembly 400 includes a piston portion 412 having a central post or projection 412A at lower connection end 414 of the fitting assembly. Additionally, a conical bias spring 416, the smaller end of which engages post 412A, is sandwiched between piston end face 412B and a hex set screw 418.

In operation, bias spring 416 and hex screw allow one to adjust the make or break pressure set point of the switch.

### Fifth Exemplary Pressure Switch

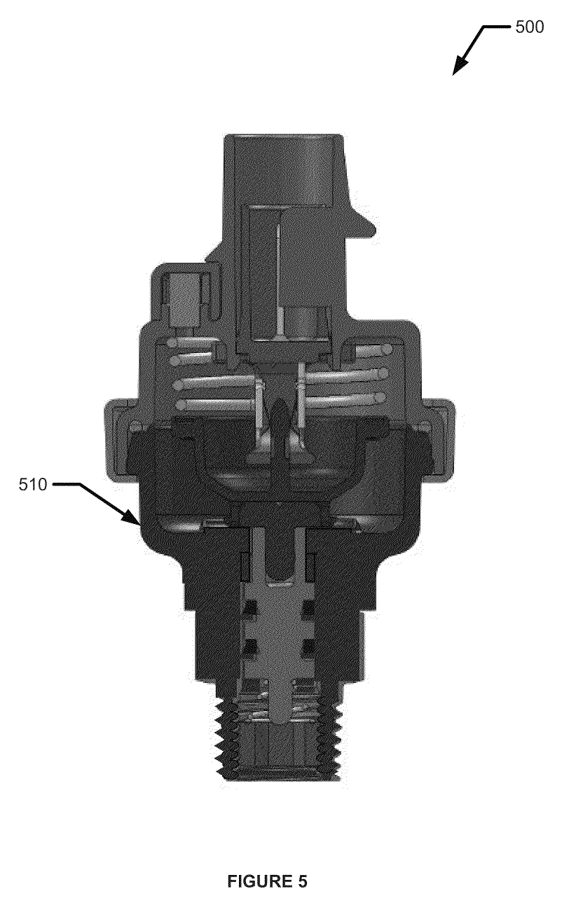

FIG. 5 shows a cross-sectional view of an exemplary pressure switch 500, which is structurally and functionally analogous, to switch 400, with the exception that switch 500 includes an integrally molded lower housing and high pressure fitting portion 510, combining the two parts into one for further cost savings. In the exemplary embodiment, this integrated housing and fitting is formed of non-filled nylon.

### Exemplary Systems

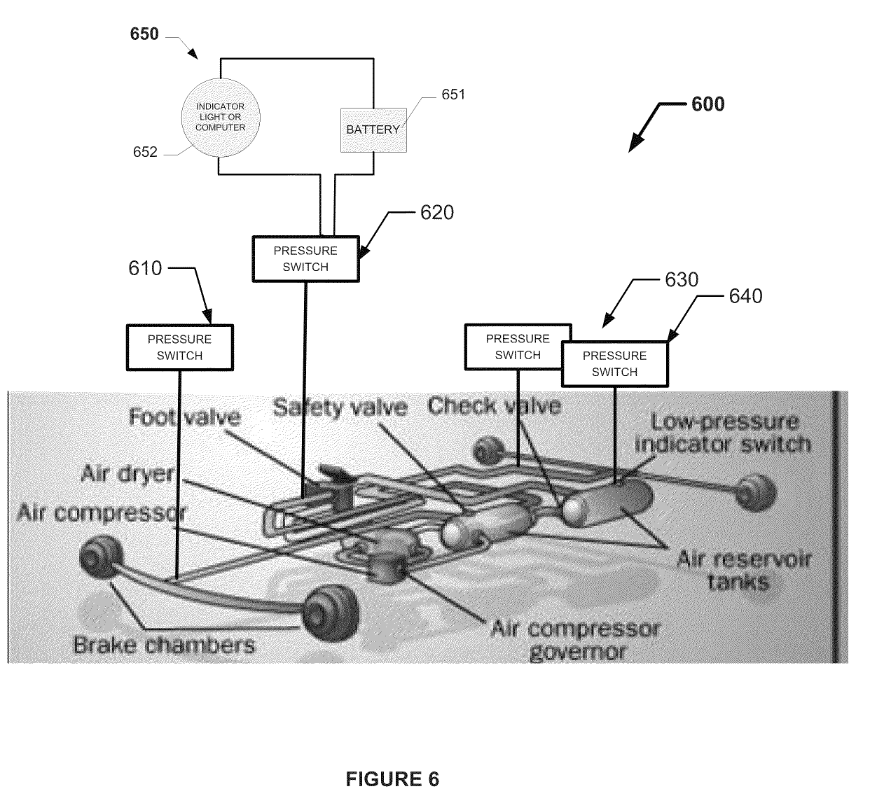

The exemplary pressure switches, components, and operating methods thereof can be used in wide variety of applications, such as air-braking systems, fuel systems, and hydraulic and pneumatic systems. FIG. 6 shows an exemplary air-braking system 600 which has a normal pressure of 120 PSI and which includes four pressure switches 610, 620, 630 and 640, each of which incorporates the teachings of pressure switches 100, 200, 300, 400 and/or 500 described above. The respective set or trip points for pressure switches 610, 620, 630, and 640 are 65, 5, 77, and 85PSI.

There is minor oil, less than 1%, mixed within the air brake system. Typically this application will operate at −40 deg. F. to 160 deg. F. Dry Graphite has been added as a lubricant to the fitting assemblies of each of the switches to enhance function at these very low temperatures. Additionally, system 600 includes a representative electrical circuit 650 which is coupled to the contacts of pressure switch 620. Circuit 650 includes a battery 651 (or other electric power source) and an indicator light or a computer 652 coupled in series with the contacts of pressure switch 620.

In operation, each time a brake pedal (foot valve or other brake actuator) in this semi-truck air-brake application is depressed (actuated), the pressure in the air-brake system rises from zero PSI up to 5PSI, moving piston portion of the pressure switch and the pushpin conductor toward the stationary contacts. When the pressure reaches 5PSI, the pushpin conductor contacts the stationary contacts completing circuit 650 and turning on the trucks rear brake lights, i.e., indicator lights 652 and/or causing communication of a logic signal to the computer.

This is a safety system with regulations requiring the switch to function very quickly; the exemplary switch turns on before the pressure reaches 6PSI. The exemplary switch must be able to handle a life expectancy of 1.5 million cycles. Conventional switches in the market are unable to achieve this many cycles.

### Exemplary Advantages

One or more of the exemplary embodiments includes or provides one or more of the following features, advantages, or attributes:
1. High positive and negative pressures are contained within the fitting, keeping fluid and pressure from the more delicate components in the switch portion of the assembly. The fitting effectively serves as high pressure portion of the housing, which allows the remaining portion of the housing to have a less rugged plastic construction.
2. The architecture of the design, which includes a housing that receives separate switch subassembly (or module) and a separate fitting (or switch actuation) subassembly allows for mixing and matching of different switch subassemblies with other fittings or switch subassemblies easily, thus allowing a variety of pressure switch variations at different switch point settings.
3. The exemplary switch includes sliding contacts which in operation keep electrical contact surfaces clean of oxidation and other contaminants. (tested with 1 ts Arizona Dust, also tested with ½ ts dry graphite)
4. The piston is able to handle high amounts of dirt and debris with self cleaning action of the seals. (Tested with ¼ ts of Arizona Dust and large grain sand)
5. The piston assembly contains two U-seals for added leak prevention. Further O-ring seal can be added on the plunger end of the Piston to further prevent any leaks occurring when piston is over-pressurized.
6. The fitting is self contained in that if the switch portion of the assembly broke off or the housing were breached in an accident, the system pressure would not be lost and potentially volatile fluid would not be lost to the atmosphere.
7. The fitting subassembly effectively replaces 1″ diameter diaphragm (effective area 0.785 sqin.) with a 0.310″ diameter piston (effective area 0.075 sqin.). This change in effective area effectively uses the same spring force of a lower diaphragm switch to equal a higher force on the new switch. The pressure of the new switch would be ˜10.5× using the same spring as it would be for use in the diaphragm switch.
8. The exemplary switch assembly has a wide pressure range. It can switch at pressures as low as 2-3 PSI switching function and greater than 5,000 PSI. Because all high pressures are contained in the fitting the pressures this switch can withstand are very large. When the piston is pressurized beyond normal operating pressures, the piston will bottom out against the inner shoulder of the fitting, effectively isolating these high forces from the push plate, pushpin, and switch module, thus preventing damage to the switch.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A pressure switch assembly comprising:
a non-metal housing including:
first and second contacts for connection to an electric circuit;
a conductive member for electrically coupling the first contact to the second contact; and
an opening;
a fitting having a first portion engaged via barbs or threads with the opening, a second portion opposite the first portion for fluid tight engagement with an external fluid system via barbs or threads, and an axial bore extending through the first and second portions, the axial bore having a first diameter portion and a second diameter portion smaller than the first diameter portion to define an annular shoulder within the fitting; and
a piston positioned at least partly within the axial bore of the fitting and having a first piston diameter portion that slideably engages with the first diameter portion of the axial bore, a second piston diameter portion that slideably engages with the second diameter portion of the axial bore, and a third piston diameter portion greater than the second diameter portion, with the third piston diameter portion extending outside the fitting and mechanically coupled to conductive member.

2. The switch of claim 1, wherein each of the first and second contacts includes a leaf contact biased toward the conductive member.

3. The switch of claim 1, wherein the fitting consists essentially of metal, and the housing consists essentially of plastic.

4. The switch of claim 1, wherein the fitting includes an intermediate hex-nut portion between the first and second portions.

5. The switch of claim 1, further comprising a push plate positioned within the housing and having a non-conductive central pin coupled to the conductive member, with the push plate in contact with the third diameter portion of the piston.

6. The switch of claim 5, further comprising: a helical calibration spring positioned within the housing around the first and second contacts and having first and second ends, with the first end adjacent to the first and second contacts and the second end contacting a surface of the push plate

7. A pressure switch assembly comprising:
a housing including:
a switch module opening;
an opening opposite the switch module opening; and
a chamber between the switch module opening and the opening opposite switch module opening;
a switch module within the switch module opening, the module including first and second contacts for connection to an electric circuit and a conductive member for electrically coupling the first contact to the second contact, with the first and second contacts positioned within chamber;
a helical calibration spring positioned with the chamber around the first and second contacts and having first and second ends, with the first end adjacent the switch module opening;
a push plate positioned within the chamber between the second end of the helical calibration spring and the threaded bore portion, the push plate having a central pin coupled to the conductive member;
a fitting having a first portion engaged with the opening opposite the switch module opening, a second portion opposite the first portion for fluid tight engagement with an external fluid system, and an axial bore extending through the first and second portions, the axial bore having a first diameter portion and a second diameter portion smaller than the first diameter portion to define an annular shoulder within the fitting;
a piston positioned at least partly within the axial bore of the fitting and having a first piston diameter portion that slideably engages with the first diameter portion of the axial bore, a second piston diameter portion that slideably engages with the second diameter portion of the axial bore, and a third piston diameter portion greater than the second diameter portion, with the third piston diameter portion extending outside the fitting and engaging with or contacting a lower portion of the push plate.

8. The switch assembly of claim 7 wherein the third piston diameter portion (referred to in the description as a plunger) is detachable from the second piston diameter portion.

9. The switch assembly of claim 7, wherein the switch module includes a guide structure having a hole through which the central pin of the push plate extends, the guide structure fixed relative to the first and second contacts to guide movement of the central pin along an axis between the first and second contacts.

10. The switch assembly of claim 9, wherein the conductive member is cylindrical and encircles a portion of the central pin.

11. The switch assembly of claim 7, wherein each of the first and second contacts includes a leaf contact biased toward the conductive member.

12. The switch assembly of claim 11, wherein the conductive member comprises a cylindrical bushing encircling the central bin and having an outer diameter greater than that of the central pin; and wherein the leaf contacts are spaced to allow contact with only the cylindrical bushing and thereby reduce friction with the central pin.

13. The switch assembly of claim 7, wherein the fitting consists essentially of metal, and the housing consists essentially of plastic.

14. The switch assembly of claim 7, wherein the fitting includes a intermediate hex-nut portion between the first and second portions.

15. The switch assembly of claim 7, wherein the first portion of the fitting includes barbs for engaging the opening of the housing.

16. A method of operating a pressure switch, the method comprising:
moving a piston within a fitting in fluid communication with a system from a first position to a second position; and
in response to movement of the piston to the second position, moving a conductor within a plastic housing along an axis between first and second contacts to make or break an electrical connection between the first and second contacts.

17. The method of claim 16, wherein the fitting is made of steel or brass and includes a first threaded portion that engages the plastic housing enclosing the conductor and the first and second contacts, and a second thread portion that engages in an external fluid system.

18. The method of claim 16, wherein the external fluid system is an air-brake system.

19. The method of claim 16, wherein the fitting and a portion of the plastic housing are integrally molded

20. The method of claim 16, wherein moving the piston comprises moving the piston along an axis and moving the conductor comprises moving the conductor along the axis.

21. A braking system comprising:
a fluid line coupled to means for braking a vehicle; and
a pressure switch in fluid communication with the fluid line carrying a fluid,
wherein the pressure switch comprises:
a non-metal housing including:
first and second contacts for connection to an electric circuit;
a conductive member for electrically coupling the first contact to the second contact; and
an opening;
a fitting having a first portion engaged via barbs or threads with the opening, a second portion opposite the first portion for fluid tight engagement with an external fluid system via barbs or threads, and an axial bore extending through the first and second portions, the axial bore having a first diameter portion and a second diameter portion smaller than the first diameter portion to define an annular shoulder within the fitting; and
a piston positioned at least partly within the axial bore of the fitting and having a first piston diameter portion that slideably engages with the first diameter portion of the axial bore, a second piston diameter portion that slideably engages with the second diameter portion of the axial bore, and a third piston diameter portion greater than the second diameter portion, with the third piston diameter portion extending outside the fitting and mechanically coupled to conductive member.

22. The braking system of claim 21, wherein the fluid is air.

23. The braking system of claim 21, wherein the fluid is a liquid.
